(19) United States
(12) Patent Application Publication
(10) Pub. No.: US 2025/0286110 A1
(43) Pub. Date: Sep. 11, 2025

(54) BATTERY MODULE

(71) Applicant: HONDA MOTOR CO., LTD., Tokyo (JP)

(72) Inventors: Hirokazu WATANABE, Saitama (JP); Hidemasa USUI, Saitama (JP)

(21) Appl. No.: 19/058,034

(22) Filed: Feb. 20, 2025

(30) Foreign Application Priority Data
Mar. 7, 2024 (JP) 2024-035102

(51) Int. Cl. H01M 10/04; H01M 50/204; H01M 50/293; H01M 50/618; H01M 50/627; H01M 50/691

(52) U.S. Cl. CPC H01M 10/0468; H01M 50/204; H01M 50/293; H01M 50/618; H01M 50/627; H01M 50/691

(57) ABSTRACT

A battery module according to one embodiment of the present invention includes: a battery cell stack in which a plurality of battery cells are stacked; a pair of end plates provided at both ends of the battery cell stack in the stacking direction; and a cushioning material arranged either between the battery cells, or between the battery cell stack and the end plates, or both. The cushioning material includes: a first pack and a second pack with an inner diameter larger than that of the first pack; gas filled in an internal space of the first pack; and liquid filled in a space between the first pack and the second pack.

This application is based on and claims the benefit of priority from Japanese Patent Application No. 2024-035102, filed on 7 Mar. 2024, the content of which is incorporated herein by reference.

### BACKGROUND OF THE INVENTION

### Field of the Invention

The present invention relates to a battery module.

### Related Art

In recent years, research and development have been conducted on battery modules that contribute to energy efficiency, in order to enable more people to access affordable, reliable, sustainable, and advanced energy. A battery module is a modularized assembly combining a plurality of battery cells, generally including a battery cell stack formed by stacking a plurality of battery cells, and a pair of end plates arranged at both ends of the battery cell stack in the stacking direction. Battery modules are used in applications requiring high current and high voltage, such as for motor drives in electric vehicles and hybrid electric vehicles.

In battery modules, consideration has been given to arranging cushioning materials either between the battery cells or between the battery cell stack and the end plates to exert pressure on the battery cells in the stacking direction. Known cushioning materials include a cushioning material having a deformable chamber and a system that supplies fluid to deform the chamber (Patent Document 1), as well as elastic bodies such as plate springs and liquid springs (Patent Document 2 and Patent Document 3).
Patent Document 1: Japanese Unexamined Patent Application, Publication No. 2020-64848
Patent Document 2: Japanese Unexamined Patent Application, Publication No. 2021-96974
Patent Document 3: European Patent Application, Publication No. 3886202

### SUMMARY OF THE INVENTION

In the field of battery module technology, improving the electrical capacity is a recognized challenge. An effective approach to improving the electrical capacity of a battery module is to use a cushioning material to exert uniform pressure on each battery cell incorporated into the battery module. When using a cushioning material having a function of thermal dissipation to release heat from within the battery cell stack to outside, and a thermal insulation property to limit heat transfer between the battery cells, the thermal insulation property is achieved in the cell stacking direction of the battery cell stack, and thermal conductivity is achieved in a direction perpendicular to the cell stacking direction, thereby facilitating the temperature control of the battery cells. However, in cases where the thickness of the battery cells partially fluctuates during charging and discharging, resulting in a partial increase or decrease in the pressure exerted by the battery cells on the cushioning material, it may become challenging for the cushioning material to exert uniform pressure on the battery cells. Reducing the size of a cushioning material is desirable in order to improve the electrical capacity per unit volume of the battery module; however, reducing the size of the cushioning material could compromise the balance of thermal dissipation and thermal insulation, potentially causing difficulty in achieving the intended effects.

The present invention has been made in view of the above circumstances, and aims to provide a battery module using a cushioning material that is capable of exerting uniform pressure on the battery cells, achieves high thermal insulation, and can be easily reduced in size. Consequently, the present invention contributes to increased energy efficiency.

The inventors of the present invention have found that the above problems can be solved by employing a structure of a cushioning material that includes: a double-pack structure including a first pack and a second pack with an inner diameter larger than that of the first pack, and having both ends sealed; gas filled within the first pack; and liquid filled in the space between the first pack and the second pack, thereby arriving at completion of the present invention. Thus, the present invention provides the following.
(1) A battery module, including: a battery cell stack in which a plurality of battery cells are stacked; a pair of end plates provided at both ends of the battery cell stack in a stacking direction; and a cushioning material arranged either between the battery cells, or between the battery cell stack and the end plates, or both. The cushioning material includes: a first pack and a second pack with an inner diameter larger than that of the first pack; gas filled in an internal space of the first pack; and liquid filled in a space between the first pack and the second pack.

With the battery module as described in (1), for example, even in cases where the pressure exerted by the battery cell on the cushioning material partially increases or decreases, the liquid filled in the space between the first pack and the second pack maintains the internal pressure of the cushioning material uniform, and thus the pressure exerted by the cushioning material on the battery cell is maintained uniform. Since gas is filled inside the first pack, the thermal insulation property of the cushioning material is enhanced. Furthermore, the cushioning material consists of the double-pack structure including the first pack and the second pack, which can be relatively easily configured, and easily reduced in size.
(2) In the battery module as described in (1), the first pack and the second pack are spaced apart from each other.

With the battery module as described in (2), the thermal conductivity between the first pack and the second pack is reduced, thereby improving the thermal insulation performance of the cushioning material.
(3) In the battery module as described in (1) or (2), the cushioning material includes an air ventilation tube connected to the internal space of the first pack.

With the battery module as described in (3), the internal pressure of the cushioning material can be regulated by introducing gas into the internal space of the first pack or exhausting the gas through the air ventilation tube. Therefore, the pressure exerted by the cushioning material on the battery cells can be maintained constant.
(4) In the battery module as described in any one of (1) to (3), the cushioning material includes a liquid supply tube and a liquid discharge tube connected to the space between the first pack and the second pack.

The battery module as described in (4) is capable of regulating the internal pressure of the cushioning material by introducing liquid into the space between the first pack and the second pack through the liquid supply tube or discharging the liquid through the liquid discharge tube. Therefore, the pressure exerted by the cushioning material on the battery cells can be maintained more constant. By continuously flowing temperature-controlled liquid in the space between the first pack and the second pack via the liquid supply tube and the liquid discharge tube, the temperature of the cushioning material can be regulated. Therefore, the thermal insulation property of the cushioning material is further improved.

The present invention makes it possible to provide a battery module using a cushioning material that is capable of exerting uniform pressure on the battery cells, achieves high thermal insulation, and can be easily reduced in size.

### BRIEF DESCRIPTION OF THE DRAWINGS

FIG. 1 is a cross-sectional view of a battery module according to a first embodiment of the present invention;

FIG. 2 is a cross-sectional view taken along the line II-II of FIG. 1;

FIG. 3 is a cross-sectional view of a battery cell that can be used in the battery module according to the first embodiment of the present invention;

FIG. 4 is a cross-sectional view illustrating a battery module according to a second embodiment of the present invention;

FIG. 5 is a plan view of a cushioning material used in the battery module according to the second embodiment of the present invention;

FIG. 6 is a first modification of the cushioning material used in the battery module according to the present invention;

FIG. 7 is a second modification of the cushioning material used in the battery module according to the present invention;

FIG. 8 is a third modification of the cushioning material used in the battery module according to the present invention; and

FIG. 9 is a fourth modification of the cushioning material used in the battery module according to the present invention.

### DETAILED DESCRIPTION OF THE INVENTION

Hereinafter, embodiments of the present invention will be described with reference to the drawings. However, the embodiments described below are merely illustrative and do not limit the scope of the present invention.

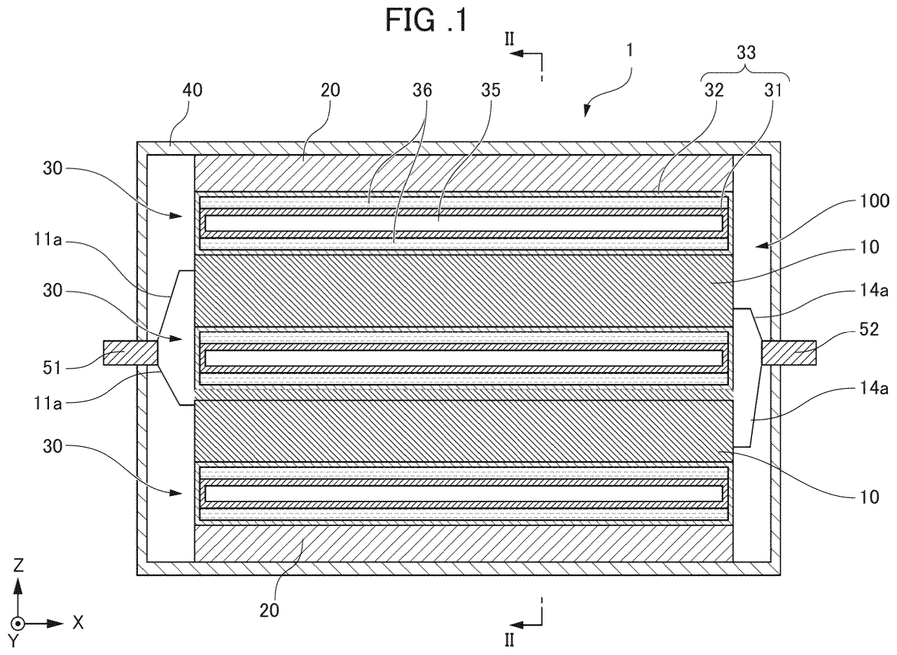

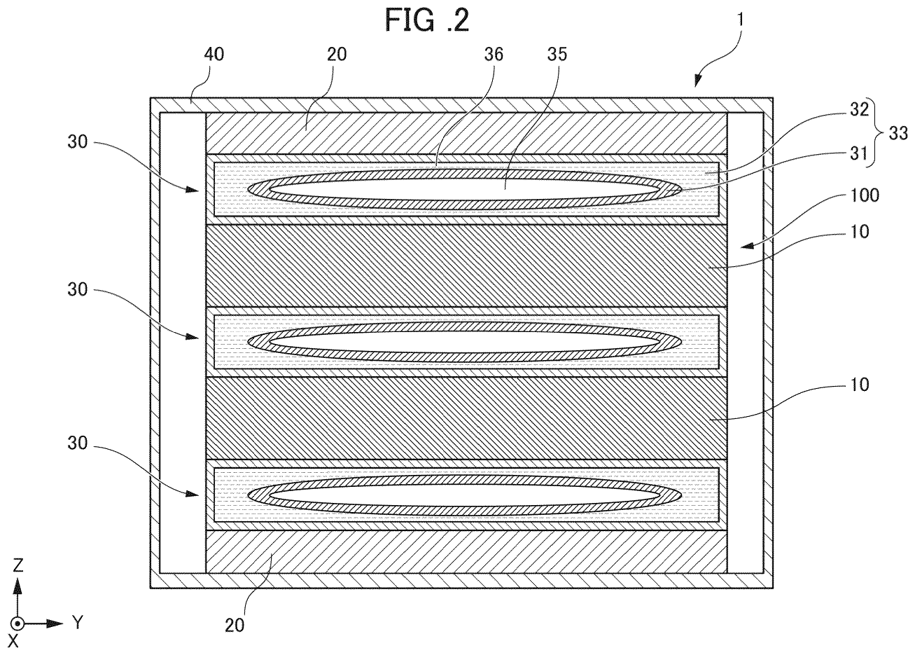

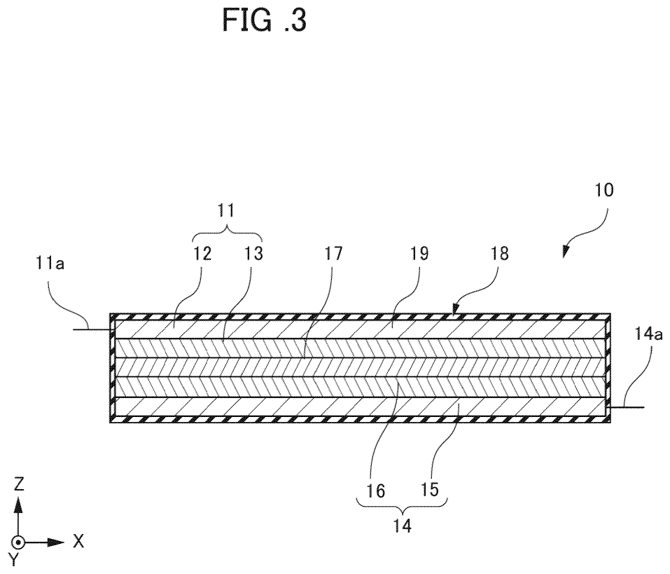

FIG. 1 is a cross-sectional view of a battery module according to a first embodiment of the present invention. FIG. 2 is a cross-sectional view taken along the line II-II of FIG. 1. FIG. 3 is a cross-sectional view of a battery cell that can be used in the battery module according to the first embodiment of the present invention.

As illustrated in FIGS. 1 and 2, a battery module 1 includes: a battery cell stack 100 formed by stacking a plurality of battery cells 10; a pair of end plates 20 provided at both ends of the battery cell stack in the stacking direction (Z direction in FIG. 1); and a cushioning material 30 arranged between the battery cells 10 and between the battery cell stack 100 and the end plates 20. The battery cell stack 100, the end plates 20, and the cushioning material 30 are housed within a module case 40. The module case 40 includes a positive electrode terminal 51 and a negative electrode terminal 52. The positive electrode terminal 51 and the negative electrode terminal 52 are arranged in opposing positions in one direction (X direction in FIG. 1). The positive electrode terminal 51 is connected to a positive electrode lead wire 11a of the battery cell 10. The negative electrode terminal 52 is connected to a negative electrode lead wire 14a of the battery cell 10.

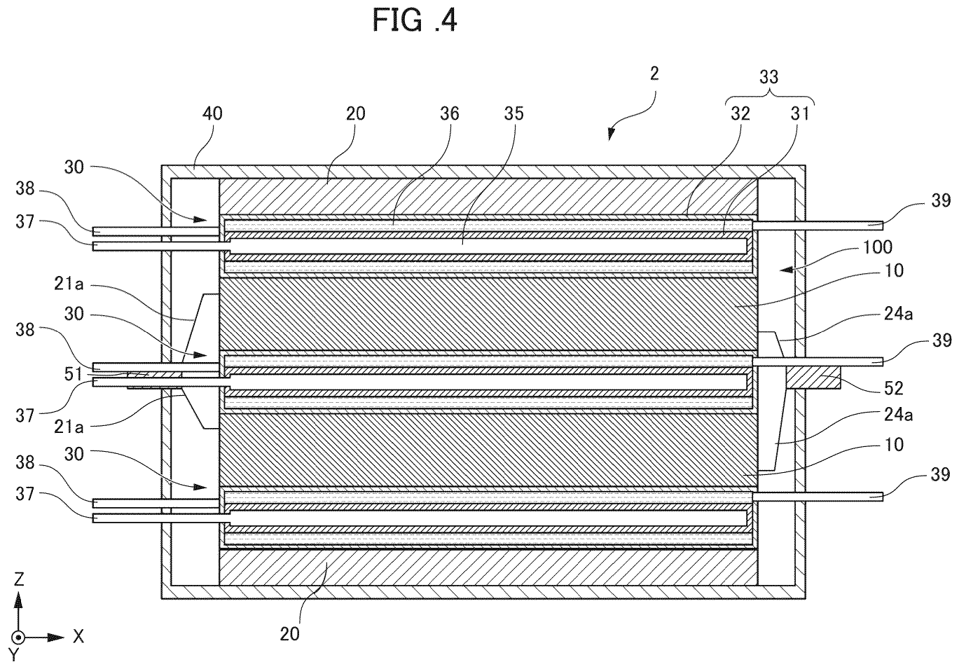

The battery cell 10 is a battery utilizing lithium ions as the charge transfer medium. As illustrated in FIG. 3, the battery cell 10 includes an electrode stack 18, which is formed by stacking a positive electrode layer 11 and a negative electrode layer 14 with a solid electrolyte layer 17 interposed therebetween, and a housing 19 that houses the electrode stack 18. The positive electrode layer 11 includes a positive electrode current collector 12 and a positive electrode active material layer 13. The negative electrode layer 14 includes a negative electrode current collector 15 and a metal layer 16. When the battery cell 10 is charged, lithium ions released from the positive electrode active material layer 13 pass through the solid electrolyte layer 17 and deposit on the surface of the metal layer 16 of the negative electrode layer 14, forming a lithium deposition layer that increases the thickness of the negative electrode layer 14. This lithium deposition layer acts as the negative electrode active material layer, and dissolves upon discharge by releasing lithium ions. Therefore, the volume of the battery cell 10 changes with charging and discharging. Consequently, the pressure exerted by the battery cell 10 on the cushioning material 30 changes during charging and discharging. The stacking direction of the electrode stack 18 aligns with the stacking direction of the battery cell stack 100. In other words, the plurality of battery cells 10 in the battery module 1 are stacked along the stacking direction of the electrode stack 18. In the battery cell 10 illustrated in FIG. 4, only one electrode stack 18 is housed within the housing 19, although a plurality of electrode stacks 18 may be housed within the housing 19.

The positive electrode current collector 12 is not particularly limited in material or shape so long as having a function as a current collector for the positive electrode layer 11. Examples of materials for the positive electrode current collector 12 include aluminum, aluminum alloy, stainless steel, nickel, iron, and titanium, in which aluminum, aluminum alloy, and stainless steel are preferred. Examples of the shape of the positive electrode current collector 12 include foil and plate.

The positive electrode active material layer 13 contains at least one type of positive electrode active material. There is no particular limitation on the positive electrode active material, and may be any materials commonly used for positive electrode layers in solid-state secondary batteries. Examples of positive electrode active materials include layered active materials containing lithium, spinel-type active materials, and olivine-type active materials. Specific examples of positive electrode active materials include lithium cobalt oxide (LiCoO₂), lithium nickel oxide (LiNiO₂), LiNiₚMn_{q}CoᵣO₂ (where p+q+r=1), LiNiₚAl_{q}CoᵣO₂ (where p+q+r=1), lithium manganese oxide (LiMn₂O₄), heteroelement-substituted Li—Mn spinel such as Li₁₊ₓMn_{2-x-y}MO₄ (where x+y=2, and M is at least one element selected from Al, Mg, Co, Fe, Ni, and Zn), lithium titanate (an oxide containing Li and Ti), and lithium metal phosphate (LiMPO₄, where M is at least one element selected from Fe, Mn, Co, and Ni).

The positive electrode active material layer 13 may optionally contain a solid electrolyte to improve lithium ion conductivity. A conductive additive may be optionally contained to improve electrical conductivity. A binder may be optionally contained to impart flexibility or other properties. The solid electrolyte, the conductive additive, and the binder are not particularly limited, and may be any materials commonly used for positive electrode layers in solid-state secondary batteries.

The material for the positive electrode lead wire 11a may be the same as the material for the positive electrode current collector 12, or may be different from the material for the positive electrode current collector 12. The positive electrode lead wire 11a may be integrally connected to the positive electrode current collector 12.

The negative electrode current collector 15 is not particularly limited in material or shape so long as having a function as a current collector for the negative electrode layer 14. Examples of materials for the negative electrode current collector 15 include nickel, copper, and stainless steel. Examples of the shape of the negative electrode current collector 15 include foil and plate.

The metal layer 16 is not particularly limited in material or shape so long as having a function of densely depositing lithium ions. The metal layer 16 may be a metallic lithium layer or a layer of a metal that forms an alloy with lithium. Examples of metals that form alloys with lithium include Mg, Si, Au, Ag, In, Ge, Sn, Pb, Al, and Zn. The metal forming the metal layer 16 may be in the form of powder or a thin film. By employing the negative electrode layer 14 including the metal layer 16, a uniform lithium deposition layer can be formed on the surface of the metal layer 16.

The material for the negative electrode lead wire 14a may be the same as the material for the negative electrode current collector 15, or may be different from the material for the negative electrode current collector 15. The negative electrode lead wire 14a may be integrally connected to the negative electrode current collector 15.

The solid electrolyte layer 17 contains at least one type of solid electrolyte. The solid electrolyte is not particularly limited so long as having lithium ion conductivity; examples include sulfide solid electrolytes, oxide solid electrolytes, nitride solid electrolytes, and halide solid electrolytes.

Examples of sulfide solid electrolytes include Li₂S—P₂S₅ and Li₂S—P₂S₅—LiI. The sulfide solid electrolyte may have an argyrodite-type crystal structure.

Examples of oxide solid electrolytes include NASICON-type oxides, garnet-type oxides, and perovskite-type oxides. An example of a NASICON-type oxide is an oxide containing Li, Al, Ti, P, and O (e.g., Li_{1.5}Al_{0.5}Ti_{1.5}(PO₄)₃). An example of a garnet-type oxide is an oxide containing Li, La, Zr, and O (e.g., Li₇La₃Zr₂O₁₂). An example of a perovskite-type oxide is an oxide containing Li, La, Ti, and O (e.g., LiLaTiO₃).

The housing 19 is designed to be expandable and contractible to accommodate changes in the volume of the battery cell 10 during charging and discharging. Examples of materials that can be used for the housing 19 include a laminated film. The laminated film may be a three-layer film composed of an inner resin layer, a metal layer, and an outer resin layer, stacked in this order from the inner side. The outer resin layer may be a polyamide (nylon) layer or polyethylene terephthalate (PET) layer, the metal layer may be an aluminum layer, and the inner resin layer may be a polyethylene or polypropylene layer.

The end plates 20 function to restrain the battery cell stack 100 in the stacking direction. The restraining force of the end plates 20 allows for regulating the surface pressure exerted by the cushioning material 30 on the battery cell stack. The material for the end plate 20 is not particularly limited, and various materials commonly used for end plates for battery modules can be employed.

The cushioning material 30 functions to equalize the surface pressure exerted on the battery cells 10. The surface pressure exerted on the battery cells 10 is, for example, 1 MPa or more.

The cushioning material 30 includes a double-pack structure 33 that includes a first pack 31 and a second pack 32 with an inner diameter larger than that of the first pack 31. The first pack 31 and the second pack 32 are spaced apart from each other. Gas is filled in a first space 35 inside the first pack 31. Liquid is filled in a second space 36 between the first pack 31 and the second pack 32.

The area ratio between the first space 35 and the second space 36 in a cross-section perpendicular to the axial direction of the cushioning material 30 may be set from a standpoint of thermal insulation and thermal conductivity of the cushioning material 30. The ratio of the cross-sectional area of the first space 35 to the total cross-sectional area of the cushioning material 30 is preferably within a range of 20 to 50% from a standpoint of thermal insulation, and is preferably within a range of 50 to 80% or less from a standpoint of thermal conductivity. Nitrogen gas, for example, may be used as the gas filled in the first space. Examples of liquids that can be used for filling the second space 36 include mineral-based hydraulic oil, phosphate ester-based hydraulic oil, water, and glycol-based solvents.

The cushioning material 30 can be manufactured by, for example, enclosing a first tubular member containing gas within a second tubular member with an inner diameter larger than that of the first tubular member, filling the space between the first tubular member and the second tubular member with liquid, and then sealing the second tubular member. Examples of materials that can be used for the first tubular member and the second tubular member include a laminated film.

The module case 40 houses the battery cell stack 100 and the end plates 20. The material for the module case 40 is not particularly limited, and various materials commonly used for battery module cases can be employed. The material for the positive electrode terminal 51 may be the same as the material for the positive electrode lead wire 11a, or may be different from the material for the positive electrode lead wire 11a. The material for the negative electrode terminal 52 may be the same as the material for the negative electrode lead wire 14a, or may be different from the material for the negative electrode lead wire 14a.

In the battery module 1 of the present embodiment established in the configuration described above, even in cases where the volume of the battery cell 10 increases during charging, resulting in a partial increase in the pressure exerted by the battery cell 10 on the cushioning material 30, or in cases where the volume of the battery cell 10 decreases during discharging, resulting in a partial decrease in the pressure exerted by the battery cell 10 on the cushioning material 30, the internal pressure of the cushioning material 30 is maintained uniform by the liquid filled in the second space 36 between the first pack 31 and the second pack 32. Consequently, the pressure exerted by the cushioning material 30 on the battery cell can be maintained uniform. The presence of the gas filled in the first space 35 inside the first pack 31 enhances the thermal insulation of the cushioning material 30. The cushioning material 30 consists of the double-pack structure 33 including the first pack 31 and the second pack 32, which is relatively simple in structure, enhancing the ease of size reduction. The first pack 31 and the second pack 32 are spaced apart from each other, reducing thermal conductivity between the first pack 31 and the second pack 32, thereby improving the thermal insulation of the cushioning material 30.

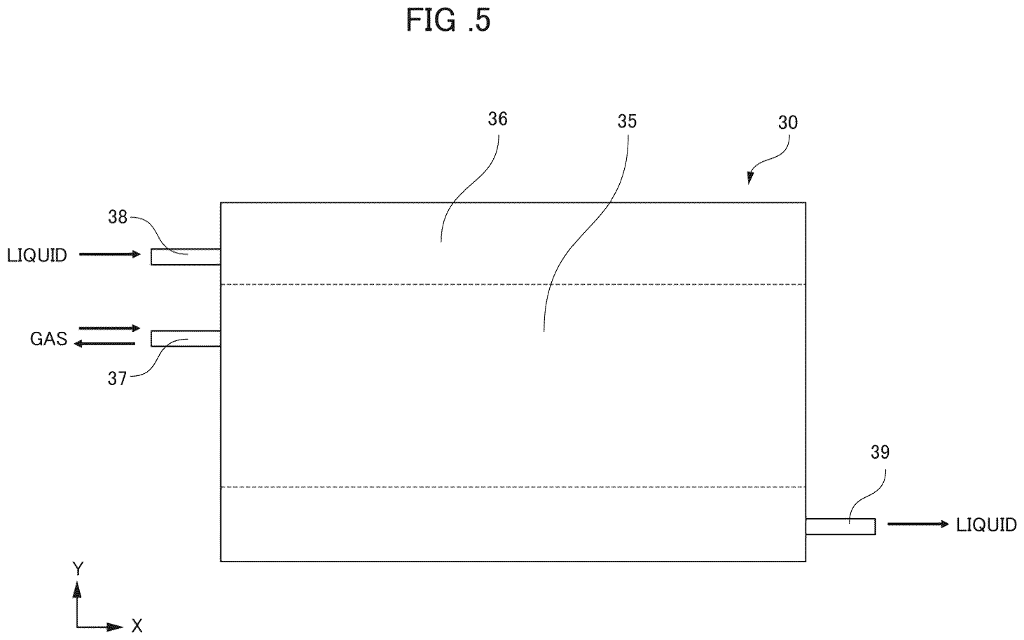

FIG. 4 is a cross-sectional view illustrating a battery module according to a second embodiment of the present invention. FIG. 5 is a plan view illustrating a cushioning material used in the battery module of the second embodiment.

As illustrated in FIGS. 4 and 5, the battery module 2 of the second embodiment is configured similarly to the battery module 1 described above, except that it includes an air ventilation tube 37 connected to the first space 35 of the cushioning material 30, and a liquid supply tube 38 and a liquid discharge tube 39 connected to the second space 36. Therefore, the same reference numbers are assigned to the components common to the battery module 1, and descriptions thereof are omitted.

The air ventilation tube 37 functions as an inlet and outlet for the gas within the first space 35. For example, when the volume of the battery cell 10 increases during charging, resulting in a partial increase in the pressure exerted by the battery cell 10 on the cushioning material 30 and a corresponding increase in the internal pressure of the cushioning material 30, gas is exhausted from the first space 35 through the air ventilation tube 37, thereby allowing for lowering the internal pressure of the cushioning material 30. Conversely, when the volume of the battery cell 10 decreases during discharging, resulting in a partial decrease in the pressure exerted by the battery cell 10 on the cushioning material 30, gas is introduced from the outside into the first space 35 through the air ventilation tube 37, thereby allowing for raising the internal pressure of the cushioning material 30. Furthermore, regardless of whether being during charging or discharging, the pressure exerted by the cushioning material 30 on the battery cell 10 can be regulated by introducing gas into the first space 35 or exhausting the gas from the first space 35 through the air ventilation tube 37.

The liquid supply tube 38 functions as an inlet for the liquid within the second space 36, while the liquid discharge tube 39 functions as an outlet for the liquid within the second space 36. For example, when the volume of the battery cell 10 decreases during discharging, resulting in a partial decrease in the pressure exerted by the battery cell 10 on the cushioning material 30, liquid is introduced from the outside into the second space 36 through the liquid supply tube 38, thereby allowing for raising the internal pressure of the cushioning material 30. When the volume of the battery cell 10 increases by charging, resulting in a partial increase in the pressure exerted by the battery cell 10 on the cushioning material 30 and a corresponding increase in the internal pressure of the cushioning material 30, liquid is discharged from the second space 36 to the outside through the liquid discharge tube 39, thereby allowing for lowering the internal pressure of the cushioning material 30. Furthermore, regardless of whether being during charging or discharging, the pressure exerted on the battery cell 10 can be regulated by way of the cushioning material 30 to regulate the internal pressure of the first space 35. Additionally, regardless of whether being during charging or discharging, the pressure exerted by the cushioning material 30 on the battery cell 10 can be regulated by introducing liquid into the second space 36 through the liquid supply tube 38 or discharging the liquid through the liquid discharge tube 39. The internal temperature of the cushioning material 30 can also be regulated by supplying temperature-controlled liquid into the second space 36 through the liquid supply tube 38 and discharging liquid through the liquid discharge tube 39.

The battery module 2 of the second embodiment achieves the same effects as the battery module 1 does, since the cushioning material 30 includes the double-pack structure 33 including the first pack 31 and the second pack 32, gas filled in the first space 35, and liquid filled in the second space 36, similarly to the battery module 1. Furthermore, the battery module 2 of the second embodiment is capable of regulating the internal pressure of the cushioning material 30 by introducing/exhausting gas into/from the first space 35 through the air ventilation tube 37, and thus is capable of maintaining constant pressure exerted by the cushioning material 30 on the battery cell 10. Additionally, the battery module 2 of the second embodiment introduces liquid into the second space 36 through the liquid supply tube 38 or discharges the liquid through the liquid discharge tube 39, thereby allowing for regulating the internal pressure of the cushioning material 30, and thus is capable of maintaining more constant pressure exerted by the cushioning material 30 on the battery cell 10. By continuously circulating temperature-controlled liquid in the second space 36 through the liquid supply tube 38 and the liquid discharge tube 39, the temperature of the cushioning material 30 can be regulated, thereby further enhancing the thermal insulation of the cushioning material 30.

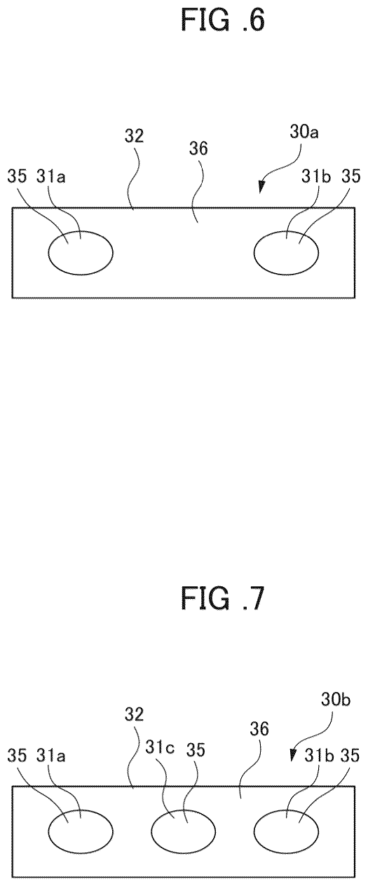

In the battery module 1 of the first embodiment and the battery module 2 of the second embodiment, the cushioning material 30 includes the double-pack structure 33 including one first pack 31 inside of the second pack 32; however, the configuration of the cushioning material 30 is not limited to this. For example, two or more first packs 31 may be provided within the second pack 32. Modifications to the cushioning material 30 are illustrated in FIGS. 6 to 9.

FIG. 6 is a first modification of the cushioning material used in the battery module according to the present invention; A cushioning material 30a of the first modification includes two first packs 31a and 31b within the second pack 32. The first pack 31a and the first pack 31b are arranged near the ends of the second pack 32. Gas is filled in the first space 35 within the first pack 31a, 31b, and liquid is filled in the second space 36 between the first pack 31a, 31b and the second pack 32. The gas-filled first space 35 exhibits higher thermal insulation performance, as compared to the liquid-filled second space 36. The liquid-filled second space 36 exhibits higher cooling performance, as compared to the gas-filled first space 35. Consequently, the cushioning material 30a of the first modification exhibits higher thermal insulation performance at the ends of the second pack 32 and higher cooling performance at the center of the second pack 32, as compared to the cushioning material 30.

FIG. 7 is a second modification of the cushioning material used in the battery module according to the present invention. A cushioning material 30b of the second modification includes an additional first pack 31c arranged between the first pack 31a and the first pack 31b of the first modification. As a result, the cushioning material 30b of the second modification achieves more uniform thermal insulation performance and cooling performance, as compared to the cushioning material 30a of the first modification.

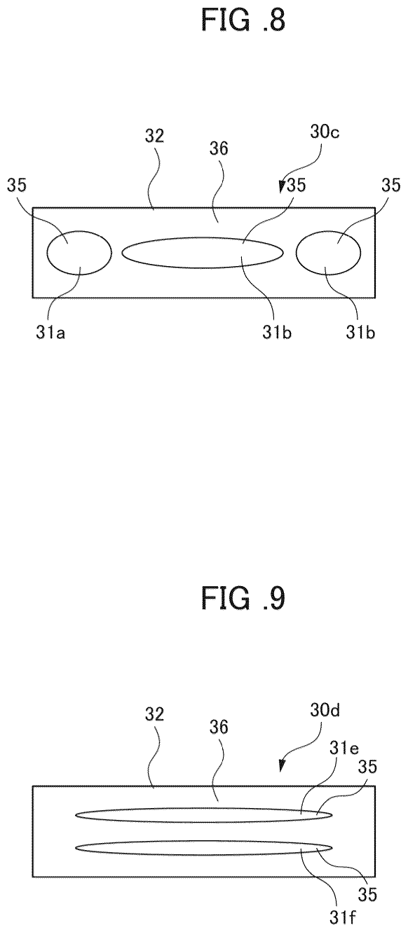

FIG. 8 is a third modification of the cushioning material used in the battery module according to the present invention. A cushioning material 30c of the third modification is configured such that the first pack 31c arranged at the center of the second pack 32 in the cushioning material 30d of the second modification is modified to a flattened, elliptical first pack 31d, and the second space 36 is modified to be wider. Therefore, the cushioning material 30c of the third modification exhibits higher cooling performance at the center of the second pack 32, as compared to the cushioning material 30b of the second modification.

FIG. 9 is a fourth modification of the cushioning material used in the battery module according to the present invention. A cushioning material 30d of the fourth modification is configured such that two flattened, circular first packs 31e and 31f are arranged at the center of the second pack 32, in parallel along a direction orthogonal to the thickness direction of the second pack 32. Therefore, the cushioning material 30d of the fourth modification exhibits higher cooling performance at the ends of the second pack 32 and higher thermal insulation performance at the center of the second pack 32, as compared to the cushioning material 30.

As shown by the first packs 31a to 31f of the cushioning materials 30a to 30d, the balance between cooling performance and thermal insulation performance of the cushioning material can be adjusted based on the shape and arrangement of the first pack(s).

The preferred embodiments of the present invention have been described above. However, the present invention is not limited to these embodiments, and can be modified as appropriate.

For example, in the embodiments described above, the first pack 31 and the second pack 32 of the cushioning material 30 are spaced apart; however, the arrangement of the first pack 31 and the second pack 32 is not limited to this. The first pack 31 and the second pack 32 may be partially in contact with each other.

In the embodiments described above, the battery cell 10 has been described as a solid-state battery including the solid electrolyte layer 17; however, the battery cell 10 is not limited to this configuration. The battery cell 10 may alternatively be a non-aqueous battery using an organic electrolytic solution as the electrolyte, or a polymer battery using a polymer gel (polymer).

In the embodiments described above, the cushioning materials 30, 130 are arranged both between the battery cells 10 and between the battery cells 10 and the end plate 20; however, the positions of the cushioning materials 30, 130 are not limited to this arrangement. The cushioning materials 30, 130 only need to be arranged either between the battery cells 10, or between the battery cells 10 and the end plates 20, or both.

### EXPLANATION OF REFERENCE NUMERALS

1, 2: battery module
10: battery cell
11: positive electrode layer
11a: positive electrode lead wire
12: positive electrode current collector
13: positive electrode active material layer
14: negative electrode layer
14a: negative electrode lead wire
15: negative electrode current collector
16: metal layer
17: solid electrolyte layer
18: electrode stack
19: housing
20: end plate
30, 30a, 30b, 30c, 30d: cushioning material
31, 31a, 31b, 31c, 31d, 31e, 31f: first pack
32: second pack
33: double-pack structure
35: first space
36: second space
37: air ventilation tube
38: liquid supply tube
39: liquid discharge tube
40: module case
51: positive electrode terminal
52: negative electrode terminal

What is claimed is:

1. A battery module, comprising:
a battery cell stack in which a plurality of battery cells are stacked;
a pair of end plates provided at both ends of the battery cell stack in a stacking direction; and
a cushioning material arranged either between the battery cells, or between the battery cell stack and the end plates, or both, wherein
the cushioning material includes:
a first pack and a second pack with an inner diameter larger than that of the first pack;
gas filled in an internal space of the first pack; and
liquid filled in a space between the first pack and the second pack.

2. The battery module according to claim 1, wherein the first pack and the second pack are spaced apart from each other.

3. The battery module according to claim 1, wherein the cushioning material includes an air ventilation tube connected to the internal space of the first pack.

4. The battery module according to claim 1, wherein the cushioning material includes a liquid supply tube and a liquid discharge tube connected to the space between the first pack and the second pack.
